(19) United States
(12) Patent Application Publication
(10) Pub. No.: US 2008/0306818 A1
(43) Pub. Date: Dec. 11, 2008

(54) MULTI-CLIENT STREAMER WITH LATE BINDING OF AD CONTENT

(75) Inventors: Gregory Morgan Evans, Raleigh, NC (US); Alfredo C. Issa, Apex, NC (US)

Correspondence Address: FlashPoint Technology and Withrow & Terranova, 100 Regency Forest Drive, Suite 160, Cary, NC, 27518, US

(73) Assignee: QURIO HOLDINGS, INC., Raleigh, NC (US)

(21) Appl. No.: 11/760,013

(22) Filed: Jun. 8, 2007

(51) Int. Cl. G06Q 30/00

(52) U.S. Cl. 705/14

(57) ABSTRACT

A late-binding multi-client streamer utilizing Remote Direct Memory Access (RDMA) transfers to obtain video and advertisement content is provided. For each client device, the streamer receives a video content selection. In response, the streamer initiates an RDMA transfer of the video content or a segment of the video content from a storage device of a video content server to an associated video buffer and begins streaming the video content from the video buffer to the client device. When an upcoming advertisement slot in the video content is detected, the streamer initiates an RDMA transfer of an advertisement for the ad slot from a storage device associated with an advertisement content server to an associated ad buffer. The streamer then inserts the advertisement from the ad buffer into the ad slot in the video content as the video content is streamed to the client device.

### FIELD OF THE INVENTION

The present invention relates to late-binding of advertisements to video content.

### BACKGROUND OF THE INVENTION

Targeted or narrowcast advertising provides an effective model for merchants to reach consumers. For example, a business selling children's apparel can benefit from narrowcast ad distribution by limiting its advertising to parents. As another example, advertisements may be matched with content being viewed and preferences of the viewer in order to provide a personalized viewing experience. Additionally, late-binding of advertisements may be combined with narrowcasting to provide even greater value to the consumer and merchant. With late-binding, advertisements are matched to and inserted into content during playback. As such, the times at which advertisements are presented and the number of times that an advertisement is presented can easily be controlled.

One issue with narrowcasting and late-binding of advertisements is that current digital cable television, satellite television, and Internet Protocol Television (IPTV) architectures do not efficiently scale to accommodate late-binding of narrowcast advertisements as the narrowcasting becomes more targeted and the number of users grows. As such, there is a need for a system and method providing efficient late-binding of narrowcast advertisements in a digital cable television, satellite television, IPTV system, or the like.

### SUMMARY OF THE INVENTION

The present invention provides a late-binding multi-client streamer utilizing Remote Direct Memory Access (RDMA) transfers to obtain video and advertisement content. In general, the streamer utilizes RDMA transfers to obtain video content and advertisements to be inserted into the video content for each of a number of client devices. More specifically, for each remote client device, the streamer receives a video content selection. In response, the streamer initiates an RDMA transfer of the video content or a segment of the video content from a storage device of a video content server to an associated video buffer and begins streaming the video content from the video buffer to the client device. When an upcoming advertisement slot in the video content is detected or predicted, the streamer initiates an RDMA transfer of an advertisement for the ad slot from a storage device associated with an advertisement content server to an associated ad buffer. The streamer then inserts the advertisement from the ad buffer into the ad slot in the video content as the video content is streamed to the client device.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system incorporating a number of Remote Direct Memory Access (RDMA) to Internet Protocol Television (IPTV) streamers according to one embodiment of the present invention;

FIG. 2 is a block diagram of one of the RDMA to IPTV streamers of FIG. 1 according to one embodiment of the present invention;

FIG. 3 illustrates an initialization process for the RDMA to IPTV streamer of FIG. 2 according to one embodiment of the present invention;

FIG. 4 illustrates the operation of the RDMA to IPTV streamer of FIG. 2 according to one embodiment of the present invention; and

FIG. 5 illustrates an exemplary hardware implementation of the RDMA to IPTV streamer of FIG. 2 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

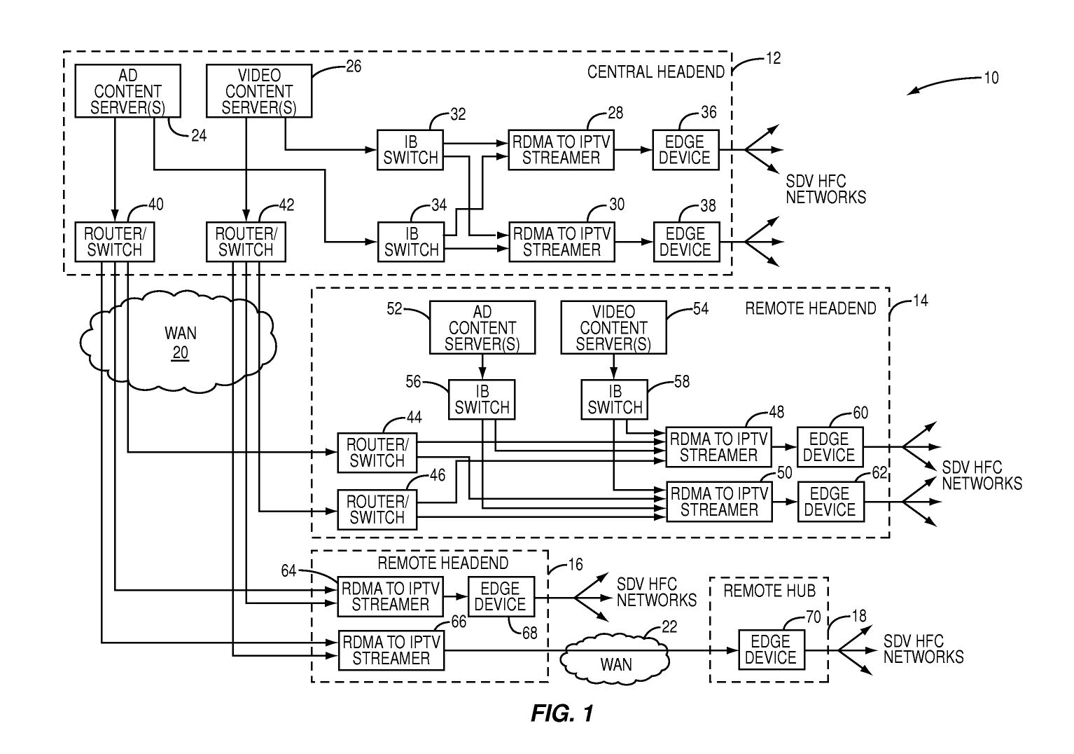

FIG. 1 illustrates a system 10 according to one embodiment of the present invention. In general, the system 10 includes a central headend 12, remote headends 14 and 16, and a remote hub 18. Note that while two remote headends 14 and 16 and one remote hub 18 are illustrated, the present invention is not limited thereto. The system 10 may include any number of zero or more remote headends 14, 16 and remote hubs 18. As illustrated, the central headend 12 is connected to the remote headends 14 and 16 via a network 20. The network 20 may be any type of Wide Area Network (WAN). In this example, the remote headend 16 is connected to the remote hub 18 via a network 22, which may be any type of WAN and may or may not be the same network as the network 20. For example, the network may be an optical network such as a metro Ethernet network.

The central headend 12 includes one or more advertisement, or ad, content servers 24 and one or more video content servers 26, which are hereinafter referred to as an ad content server 24 and a video content server 26. Note that the ad and video content servers 24 and 26 may alternatively be implemented as a single server. The ad content server 24 and content partitioning may be similar to that described in U.S. patent application Ser. No. 11/685,479, entitled LATE-BINDING OF ADVERTISEMENTS USING RDMA CONNECTIVITY, which was filed Mar. 13, 2007 and is hereby incorporated herein by reference in its entirety. In general, the ad content server 24 maintains advertisements for each of a number of advertisement categories. A range of addresses in a high-speed storage device of the ad content server 24 is allocated for each of the advertisement categories. The high-speed storage device may be, for example, a Random Access Memory (RAM) disk, hard disk drive having a sufficiently fast access time, flash drive, or the like. The ad content server 24 operates to store an advertisement for each advertisement category in the associated range of addresses within the high-speed storage device. The advertisements stored for the advertisement categories may be updated or replaced as needed or desired. Metadata describing the advertisement categories and information defining the address ranges for each advertisement category are then published or otherwise provided to the appropriate devices within the system 10, as discussed below.

Similarly, the video content server 26 stores video content. The video content server 26 may store video content corresponding to live or real-time video broadcast channels similar to traditional cable or satellite television channels. In addition or alternatively, the video content server 26 may store video content such as, for example, movies, television programs, or the like, where the video content is accessible in a Video-on-Demand or similar fashion. In one embodiment, the video content server 26 includes a high-speed storage device, where a range of addresses in the high-speed storage device is allocated to each of a number of real-time or live broadcast channels. Again, the high-speed storage device may be, for example, a RAM disk, hard disk drive having a sufficiently fast access time, flash drive, or the like. For each broadcast channel, the video content server 26 may then rotate video content for the broadcast channel into and out of the range of addresses in the high-speed storage device such that real-time or live programming is provided. In addition or alternatively, video content such as movies, television programs, or the like may be stored in specific ranges of addresses within the high-speed storage device and accessed in a Video-on-Demand or similar fashion. Information defining the range of addresses and metadata describing the content in each range of addresses are published to the appropriate devices within the system 10, as discussed below.

The central headend 12 also includes Remote Direct Memory Access (RDMA) to Internet Protocol Television (IPTV) streamers 28 and 30. Note that while the discussion herein focuses on IPTV as the streaming technology for the streamers, the present invention is not limited thereto. Other streaming technologies may be used. The RDMA to IPTV streamers 28 and 30 are connected to the ad content server 24 and the video content server 26 via a Local Area Network (LAN) of the central headend 12. More specifically, in this embodiment, the RDMA to IPTV streamers 28 and 30 are connected to the ad and video content servers 24 and 26 by Infiniband (IB) switches 32 and 34. As will be apparent to one of ordinary skill in the art, Infiniband is a serial networking technology operating at rates of 2.5 Gigabits per second (Gbps), 5 Gbps, or 10 Gbps that is well-suited to carry RDMA traffic. However, Infiniband is exemplary and not intended to limit the scope of the present invention. Other networking technologies capable of carrying RDMA traffic at rates desirable in the system 10 will be apparent to one of ordinary skill in the art upon reading this disclosure.

The RDMA to IPTV streamers 28 and 30 are preferably implemented in hardware or a combination of hardware and software. However, the present invention is not limited thereto. In general, the RDMA to IPTV streamer 28 operates to provide a separate streaming channel for each of a number of client devices. For example, the RDMA to IPTV streamer 28 may provide separate streaming channels for tens or hundreds of client devices. The client devices may be set-top boxes, personal computers equipped with hardware and/or software providing set-top box functionality, or the like. In this example, an edge device 36 converts the streaming channels output by the RDMA to IPTV streamer 28 into corresponding Switched Digital Video (SDV) channels delivered to the client devices over a Quadrature Amplitude Modulation (QAM) based Hybrid Fiber Coax (HFC) delivery network. Each SDV channel corresponds to a particular client device. Alternatively, each SDV channel may correspond to a group of related users or viewers. This may be particularly beneficial if the video content is broadcast television content. While SDV channels delivered over a QAM based HFC delivery network are discussed herein, the present invention is not limited thereto. For example, the streaming channels output by the RDMA to IPTV streamer 28 may be provided to the client devices via an Internet Protocol (IP) based delivery network.

In operation, the RDMA to IPTV streamer 28 utilizes RDMA transfers to obtain video content requested by a user of a client device from the video content server 26. While streaming the video content to the client device, for each detected ad slot, the RDMA to IPTV streamer 28 obtains an advertisement for the ad slot from the ad content server 24 utilizing an RDMA transfer and inserts the advertisement into the ad slot as the video content is streamed to the client device. In a similar manner, the RDMA to IPTV streamer 28 performs late-binding of advertisement content to video content to provide streaming video channels for a number of additional client devices served by the RDMA to IPTV streamer 28. Likewise, the RDMA to IPTV streamer 30 performs late-binding of advertisement content to video content to provide streaming video channels for a number of client devices served by the RDMA to IPTV streamer 30.

In the illustrated embodiment, the central headend 12 also includes routers or switches 40 and 42 connecting the ad and video content servers 24 and 26 to the remote headends 14 and 16 via the WAN 20. RDMA is also utilized to transfer advertisements and video content to the remote headends 14 and 16 via the WAN 20. An appropriate networking technology such as, for example, iWARP is used to carry the RDMA traffic over the WAN 20. As another example, RDMA over Ethernet (RoE) may be used to carry RDMA traffic over the WAN 20. As will be appreciated by one of ordinary skill in the art, RoE does not require a Transmission Control Protocol (TCP) or IP layer.

The remote headend 14 includes routers or switches 44 and 46 connecting RDMA to IPTV streamers 48 and 50 of the remote headend 14 to the ad content server 24 and the video content server 26 of the central headend 12 via the WAN 20. In this example, the remote headend 14 also includes a local ad content server 52 and a local video content server 54 connected to the RDMA to IPTV streamers 48 and 50 via a LAN of the remote headend 14. In this embodiment, Infiniband is used to carry RDMA traffic over the LAN. As such, the local ad content server 52 and the local video content server 54 are connected to the RDMA to IPTV streamers 48 and 50 via IB switches 56 and 58.

The local ad content server 52 is similar to the ad content server 24 and provides a local source of ad content that is accessible to the RDMA to IPTV streamers 48 and 50. More specifically, in one embodiment, the local ad content server 52 includes a high-speed storage device, where a range of addresses in the high-speed storage device is allocated for each of a number of advertisement categories. The range of addresses for each advertisement category and metadata or information describing each advertisement category are published to or otherwise provided to the RDMA to IPTV streamers 48 and 50. The local video content server 54 is similar to the video content server 26 and provides a local source of video content that is accessible to the RDMA to IPTV streamers 48 and 50. More specifically, in one embodiment, the local video content server 54 includes a high-speed storage device, where a range of addresses in the high-speed storage device is allocated for each of a number of movies, television programs, live or real-time television broadcast channels, or the like. The address ranges for the video content and metadata describing the video content in each address range are published or otherwise provided to the RDMA to IPTV streamers 48 and 50.

The RDMA to IPTV streamers 48 and 50 operate to provide a number of streaming channels to associated client devices via edge devices 60 and 62, respectively. In one embodiment, the edge devices 60 and 62 are Ethernet to QAM edge devices operating to convert the output channels from the RDMA to IPTV streamers 48 and 50 into SDV channels provided to the client devices via a QAM based HFC delivery network. In operation, when a user or viewer associated with a client device desires to view particular video content, the RDMA to IPTV streamer 48, 50 obtains the video content from either the local video content server 54 or the video content server 26 utilizing an RDMA transfer. As the video content is streamed to the client device, for each ad slot detected, predicted, or assigned within in the video content, the RDMA to IPTV streamer 48, 50 obtains an advertisement or the ad slot from either the local ad content server 52 or the ad content server 24 utilizing an RDMA transfer. The RDMA to IPTV streamer 48, 50 inserts the advertisement into the video content and streams the video content including the advertisement to the client device.

In the illustrated example, the central headend 12 is also connected to the remote headend 16. The remote headend 16 includes RDMA to IPTV streamers 64 and 66, which are directly connected to the WAN 20 rather than indirectly connected to the WAN 20 via routers or switches. Like the other RDMA to IPTV streamers 28, 30, 48, and 50, the RDMA to IPTV streamer 64 provides a streaming output channel for each of a number of associated client devices. In this example, an edge device 68 converts the streaming output channels of the RDMA to IPTV streamer 64 to SDV channels, which are provided to the client devices via a QAM based HFC delivery network. The RDMA to IPTV streamer 66 provides a streaming output channel for each of a number of associated client devices. However, the output of the RDMA to IPTV streamer 66 is delivered to an edge device 70 located at the remote hub 18 via the WAN 22. The edge device 70 then converts the output of the RDMA to IPTV streamer 66 into SDV channels, which are delivered to the associated client device via a QAM based HFC delivery network.

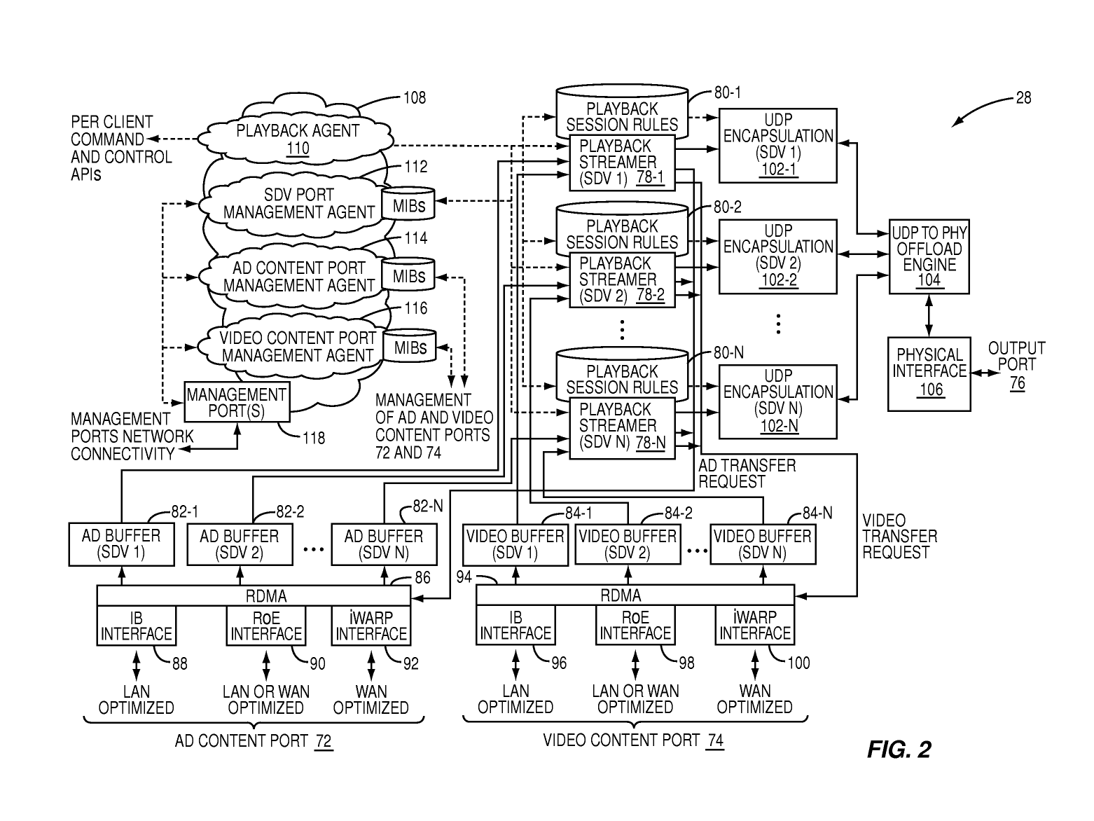

FIG. 2 is a functional block diagram of the RDMA to IPTV streamer 28 according to one embodiment of the present invention. This discussion is equally applicable to the other RDMA to IPTV streamers 30, 48, 50, 64, and 66. In general, the RDMA to IPTV streamer 28 includes an ad content port 72, a video content port 74, a streaming output port 76, and a number of playback streamers 78-1 through 78-N. Each of the playback streamers 78-1 through 78-N operates to generate or provide a streaming output channel based on playback session rules 80-1 through 80-N. In other words, each of the playback streamers 78-1 through 78-N generates the streaming output content for an SDV channel for one of the associated client devices.

For each client device served by the playback streamer 78-1, 78-N, the playback session rules 80-1, 80-N include, for example, an Internet Protocol (IP), User Datagram Protocol (UDP), or other network address corresponding to the client device for the SDV channel. In addition, the playback session rules 80-1, 80-N include metadata describing the advertisement categories for the ad content server 24 and the address ranges for the advertisement categories in the high-speed storage device of the ad content server 24; information describing or identifying the video content available from the video content server 26 and the address ranges for the video content; metadata describing the advertisement categories for the local ad content server 52 and the address ranges for the advertisement categories if applicable; and information describing or identifying the video content available from the local video content server 54 and the address ranges for the video content if applicable. The playback session rules 80-1, 80-N may also include information to assist in the selection of advertisements for the late-binding process such as, for example, metadata describing video content streamed or to be streamed by the playback streamer 78-1, 78-N and a viewer profile of the user or viewer at the client device. The viewer profile may include, for example, information describing advertisements previously watched or skipped by the viewer at the client device, user-defined preferences of the viewer at the client device, demographic information describing the viewer at the client device, biographical information describing the viewer at the client device, or the like. The playback session rules 80-1, 80-N may also include information such as whether the viewer is permitted to skip advertisements or the like.

The playback streamers 78-1 through 78-N are associated with ad buffers 82-1 through 82-N and video buffers 84-1 through 84-N. The buffers 82-1 through 82-N and 84-1 through 84-N may be implemented in, for example, one or more memory devices such a RAM, RAM disks, flash drives, or the like. Each of the ad buffers 82-1 through 82-N is dedicated to one of the SDV channels and thus to the corresponding one of the playback streamers 78-1 through 78-N. Likewise, each of the video buffers 84-1 through 84-N is dedicated to one of the SDV channels and thus to the corresponding one of the playback streamers 78-1 through 78-N. For example, the ad buffer 82-1 and the video buffer 84-1 are dedicated to an SDV channel (SDV 1) and are therefore associated with the corresponding playback streamer 78-1.

The ad content port 72 includes an RDMA layer 86 and one or more interfaces to carry RDMA traffic. In this example, the ad content port 72 includes an Infiniband (IB) optimized interface 88, a RoE optimized interface 90, and an iWARP optimized interface 92. Together the RDMA layer 86 and the interfaces 88-92 provide a number of RDMA-enabled interfaces. Note that while all three interfaces 88-92 are illustrated, the ad content port 72 may include any one or more of these interfaces 88-92 as needed or desired. Further, even if all interfaces 88-92 are included, the RDMA to IPTV streamer 28 may utilize only one, two, or all three of the interfaces 88-92. For the embodiment of the RDMA to IPTV streamer 28 illustrated in FIG. 1, only the IB optimized interface 88 is utilized. In contrast, the ad content port of the RDMA to IPTV streamers 48 and 50 of the remote headend 14 may utilize either a RoE or iWARP optimized interface to carry RDMA traffic over the WAN 20 (FIG. 1) and either an IB or RoE optimized interface to carry RDMA traffic over the associated LAN of the remote headend 14. Likewise, the ad content ports of the RDMA to IPTV streamers 64 and 66 of the remote headend 16 may utilize an RoE or iWARP optimized interface to carry RDMA traffic over the WAN 20.

The interfaces 88-92 are preferably implemented in a hardware offload engine. However, the present invention is not limited thereto. In operation, under the control of the playback streamers 78-1 through 78-N, the RDMA layer 86 utilizes RDMA to obtain advertisements from the ad content server 24 via one or more of the interfaces 88-92, which for the RDMA to IPTV streamer 28 of FIG. 1 is the IB optimized interface 88. Note that for the remote headend 14, advertisements may be obtained from the local ad content server 52. Also, in another embodiment, the local ad content server 52 may be accessible to the RDMA to IPTV streamers 28 and 30 of the central headend 12 and the RDMA to IPTV streamers 64 and 66 of the remote headend 16.

The video content port 74 includes an RDMA layer 94 and one or more interfaces to carry RDMA traffic. In this example, the video content port 74 includes an Infiniband (IB) optimized interface 96, a RoE optimized interface 98, and an iWARP optimized interface 100. Together the RDMA layer 94 and the interfaces 96-100 provide a number of RDMA enabled interfaces. Note that while all three interfaces 96-100 are illustrated, the video content port 74 may include any one or more of these interfaces 96-100 as needed or desired. Further, even if all interfaces 96-100 are included, the RDMA to IPTV streamer 28 may utilize only one, two, or all three of the interfaces 96-100. For the embodiment of the RDMA to IPTV streamer 28 illustrated in FIG. 1, only the IB optimized interface 96 is utilized. In contrast, the video content port of the RDMA to IPTV streamers 48 and 50 of the remote headend 14 may utilize either a RoE or iWARP optimized interface to carry RDMA traffic over the WAN 20 (FIG. 1) and either an IB or RoE optimized interface to carry RDMA traffic over the associated LAN of the remote headend 14. Likewise, the video content ports of the RDMA to IPTV streamers 64 and 66 of the remote headend 16 may utilize an RoE or iWARP optimized interface to carry RDMA traffic over the WAN 20.

The interfaces 96-100 are preferably implemented in a network interface hardware offload engine implemented in, for example, an Application Specific Integrated Circuit (ASIC), Field Programmable Gate Array (FPGA), or the like. However, the present invention is not limited thereto. In operation, under the control of the playback streamers 78-1 through 78-N, the RDMA layer 94 utilizes RDMA to obtain video content from the video content server 26 via one or more of the interfaces 96-100, which for the RDMA to IPTV streamer 28 of FIG. 1 is the IB optimized interface 96. Note that for the remote headend 14, video content may be obtained from the local video content server 54. Also, in another embodiment, the local video content server 54 may be accessible to the RDMA to IPTV streamers 28 and 30 of the central headend 12 and the RDMA to IPTV streamers 64 and 66 of the remote headend 16.

The output streams of the playback streamers 78-1 through 78-N are encapsulated by, in this example, UDP encapsulation functions 102-1 through 102-N. However, the present invention is not limited thereto. The encapsulation functions 102-1 through 102-N generally operate to encapsulate the output streams based on the network addresses of the associated client devices. Once encapsulated, the output streams are processed by an offload engine 104, which in this example is a UDP to physical layer (PHY) offload engine, and then delivered to the edge device 36 (FIG. 1) via a physical interface 106. As an alternative, TCP or similar transport protocol may be used instead of UDP. The physical layer may be, for example, an Ethernet interface such as a 1 Gbps-10 Gbps Ethernet interface.

The RDMA to IPTV streamer 28 also includes an operating system 108. The operating system 108 may be implemented in hardware, software, or a combination thereof. In this embodiment, the operating system 108 includes a playback agent 110, an SDV port management agent 112, an ad content port management agent 114, and a video content port management agent 116. In one embodiment, the playback agent 110 allows control of each of the playback streamers 78-1 through 78-N via a published Application Programming Interface (API). Other local server applications may directly use the API or the functionality may be available remotely to other devices through Common Object Request Broker Architecture (CORBA) or similar technology. The playback agent 110 may be used to obtain a portion of the playback session rules 80-1 through 80-N.

One or more management ports 118 connect the agents 112-116 to one or more central management systems, where the central management systems manage multiple RDMA to IPTV streamers including those illustrated in FIG. 1. In general, the agents 112-116 enable the central management systems to provide set-up rules, monitor alarms, monitor performance, or the like. Note that while four agents 110-116 are illustrated, the functionality of the playback agent 110 may be collapsed into the agents 112-116. In addition or alternatively, the agents 112-116 may be collapsed or expanded into any number of agents.

The SDV port management agent 112 may be managed by an associated central management system in order to control the client devices to which each playback streamer 78-1 through 78-N streams content. For example, the associated central management system may provide the IP or UDP address of the client device for each playback streamer 78-1 through 78-N. In addition, the SDV port management agent 112 may be used to define the bandwidth at which each playback streamer 78-1 through 78-N is to stream its output. The bandwidth may be determined based on, for example, the subscription level or rights of the user of the associated client device.

The ad content port management agent 114 receives information defining and describing the advertisement categories for the ad content server 24 and the address ranges for each of the advertisement categories from a central management system, which may be the ad content server 24. In a similar manner, the video content port management agent 116 receives information describing or identifying the video content made available by the video content server 26 and the address ranges for each video content item such as each video, movie television program, live or real-time broadcast channel, or the like. The video content port management agent 116 may, for example, receive this information from the video content server 26. Note that the ad and video content port management agents of the RDMA to IPTV streamers 48 and 50 of the remote headend 14 (FIG. 1) may also receive similar information from the local ad and video content servers 52 and 54. Note that Management Information Bases (MIBs) may be used to store information associated with the agents 112-116. The operation of the MIBs will be apparent to one of ordinary skill in the art upon reading this disclosure.

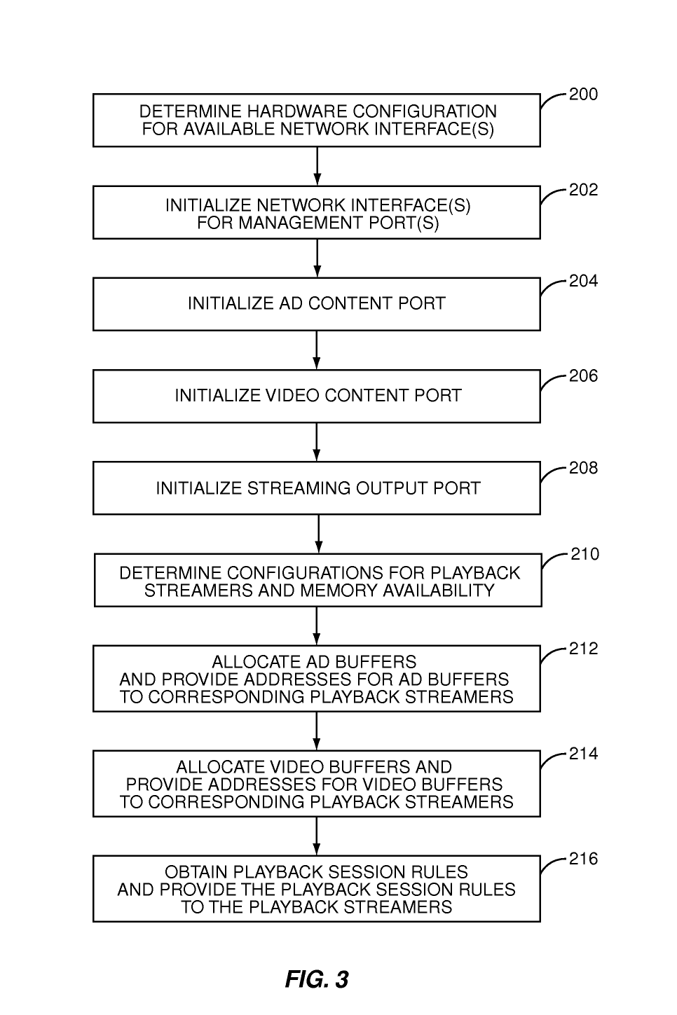

FIG. 3 illustrates an exemplary initialization process for the RDMA to IPTV streamer 28 according to one embodiment of the present invention. First, the operating system 108 (FIG. 2) determines the hardware configuration for the available network interfaces (step 200). Next, the operating system 108 initializes the network interfaces for the one or more management ports 118 (step 202). The operating system 108 then initializes the ad content port 72, the video content port 74 and the streaming output port 76 (steps 204-208). Note that the ports 72-76 may be initialized sequentially or in parallel. More specifically, for the ad content port 72, the operating system 108 launches the ad content port management agent 114. The ad content port management agent 114 determines configurations for the one or more interfaces 88-92, handshakes with its associated central management agent via a corresponding management port 118, and updates its MIB(s). Lastly, the ad content port management agent 114 initializes and tests the ad content port 72. The operating system 108 may initialize the video content port 74 and the streaming output port 76 in a similar fashion.

Next, the operating system 108 determines configurations for the playback streamers 78-1 through 78-N and memory availability (step 210). The operating system 108 then allocates the ad buffers 82-1 through 82-N and provides address ranges for the ad buffers 82-1 through 82-N to the corresponding playback streamers 78-1 through 78-N (step 212). The operating system 108 also allocates the video buffers 84-1 through 84-N and provides address ranges for the video buffers 84-1 through 84-N to the corresponding playback streamers 78-1 through 78-N (step 214). Lastly, the playback session rules 80-1 through 80-N are obtained and provided to the playback streamers 78-1 through 78-N (step 216). Note that the playback session rules 80-1 through 80-N may thereafter be updated as needed or desired. The playback session rules 80-1 through 80-N may be obtained by the agents 110-116. While the discussion herein focuses on obtaining the playback session rules 80-1 through 80-N from one or more central management systems, the present invention is not limited thereto. At least some of the playback session rules 80-1 through 80-N may be obtained from the client devices.

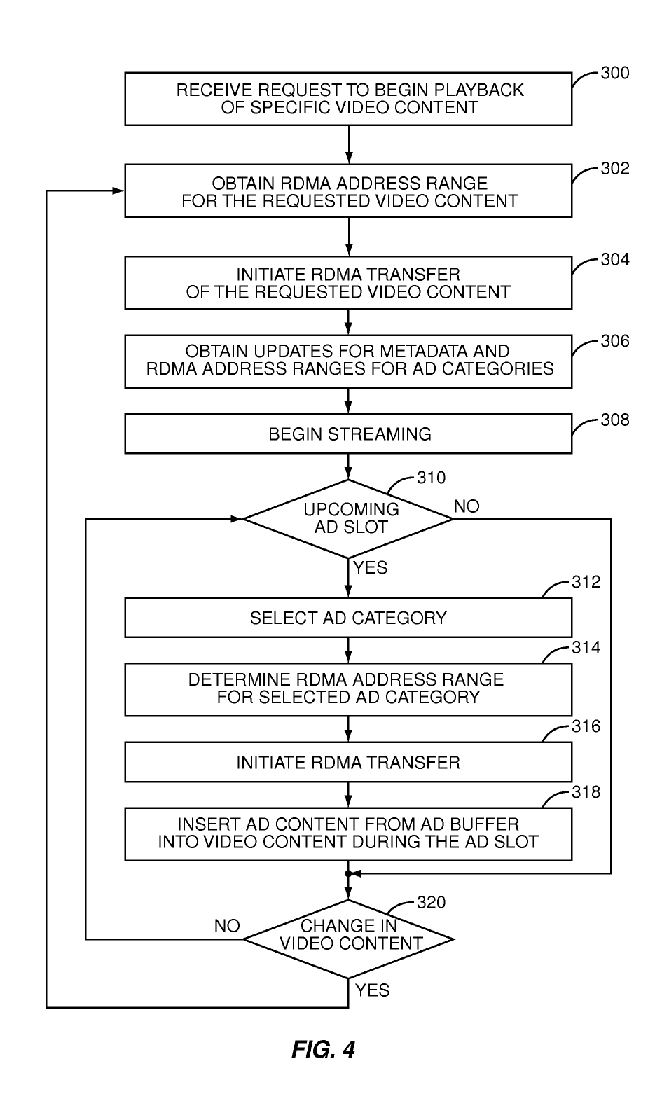

FIG. 4 illustrates the operation of the RDMA to IPTV streamer 28 of FIG. 2 according to one embodiment of the present invention. This discussion is equally applicable other RDMA to IPTV streamers. First, the RDMA to IPTV streamer 28 receives a request to begin playback of specific video content (step 300). The request may come directly from the associated client device. Alternatively, the client device may provide the request to the central management system associated with the playback agent 110, and the central management system may then provide the request to the playback agent 110. The requested video content may be, for example, a specific movie, television program, or live or real-time broadcast channel. In response to the request, the playback streamer 78-1 obtains the range of addresses for the requested video content in the high-speed storage device of the video content server 26 (step 302). As discussed above, the range of addresses for each of a number of video content items or channels were previously obtained during initialization and stored within the playback session rules 80-1.

Once the range of addresses for the requested video content is obtained, the playback streamer 78-1 initiates an RDMA transfer of the requested video content from the video content server 26 to the video buffer 84-1 for the playback streamer 78-1 (step 304). More specifically, the playback streamer 78-1 may provide a video content transfer request to the RDMA layer 94. The request may include the range of addresses for the requested video content in the high-speed storage of the video content server 26 and either the range of addresses for the video buffer 84-1 or some identifier of the playback streamer 78-1 or the video buffer 84-1 enabling the RDMA layer 94 to transfer the video content to the video buffer 84-1.

At this point, in this example, the RDMA to IPTV streamer 28 obtains updates, if any, for the metadata describing the advertisement categories and the address ranges for the advertisement categories for the ad content server 24 (step 306). In one embodiment, the ad content server 24 multicasts the metadata and address ranges for the advertisement categories to the RDMA to IPTV streamers including the RDMA to IPTV streamer 28. Alternatively, the ad content port management agent 114 may request the updates from the ad content server 24.

The RDMA to IPTV streamer 28, and more specifically the playback streamer 78-1, then begins streaming the video content from the video buffer 84-1 to the client device (step 308). As discussed above, the playback streamer 78-1 outputs the video stream. The encapsulation function 102-1 encapsulates the video stream based on the network address of the client device. From the encapsulation function 102-1, the video stream is processed by the offload engine 104 and transmitted to the edge device 36 via the physical interface 106. The edge device 36 then provides the video stream to the client device via the associated SDV channel.

While streaming the video content, the playback streamer 78-1 operates to detect upcoming ad slots (step 310). The ad slots may be marked within the video content, defined by metadata describing the video content, inserted periodically or at some predetermined time intervals, or the like. If an upcoming ad slot is not detected, operation proceeds to step 320. If an upcoming ad slot is detected, the playback streamer 78-1 selects an advertisement category for the ad slot (step 312). The playback streamer 78-1 may select the advertisement category based on a comparison of the metadata describing the advertisement categories from the ad content server 26 and information such as, for example, metadata describing the video content being streamed to the client device, information describing advertisements previously watched or skipped by the viewer at the client device, user-defined preferences of the viewer at the client device, demographic information describing the viewer at the client device, biographical information describing the viewer at the client device, or the like.

Once the advertisement category is selected, the playback streamer 78-1 determines the range of addresses for the selected advertisement category in the high-speed storage device of the ad content server 24 (step 314). As discussed above, the address ranges for each advertisement category are known to the ad content server 24. The playback streamer 78-1 then initiates an RDMA transfer of an advertisement from the range of addresses in the high-speed storage of the ad content server 24 allocated to the selected advertisement category to the ad buffer 82-1 (step 316). More specifically, the playback streamer 78-1 provides an ad transfer request to the RDMA layer 86. The request may include the range of addresses for the selected ad category and either the range of addresses for the ad buffer 82-1 or information identifying the ad buffer 82-1 or the playback streamer 78-1 enabling the RDMA layer 86 to transfer the advertisement to the ad buffer 82-1.

The playback streamer 78-1 then inserts the advertisement from the ad buffer 82-1 into the ad slot of the video content as the video content is streamed to the client device (step 318). In this example, at this point, the RDMA to IPTV streamer 28 or the playback streamer 78-1 determines whether there has been a request to change video content (step 320). If so, operation returns to step 302 and is repeated. If not, operation returns to step 310 and is repeated. Note that, if the requested video content is a live or real-time broadcast channel, the playback streamer 78-1 preferably initiates a new transfer of the video content for the broadcast channel from the corresponding range of addresses as the new content is needed. Alternatively, this functionality may be incorporated into the RDMA layer 94. As another alternative, the video content server 26 may initiate pushing of the video content to the video buffer 84-1 utilizing RDMA transfers as needed in order to provide the live or real-time broadcast channel.

While the discussion above focuses on the RDMA to IPTV streamer 28, the discussion is also applicable to the other RDMA to IPTV streamers 30, 48, 50, 64, and 66. However, slight variations may occur. For example, the RDMA to IPTV streamers 48 and 50 have access to both the local ad and video content servers 52 and 54 and the ad and video content servers 24 and 26. As such, in response to a request for video content, the RDMA to IPTV streamers 48 and 50 determine whether the requested video content is accessible from the local video content server 54. If so, an RDMA transfer is initiated to transfer the video content from the local video content server 54 to the corresponding video buffer. If not, an RDMA transfer is initiated to transfer the video content from the video content server 26 to the corresponding video buffer. Ad content transfers are initiated in a similar fashion.

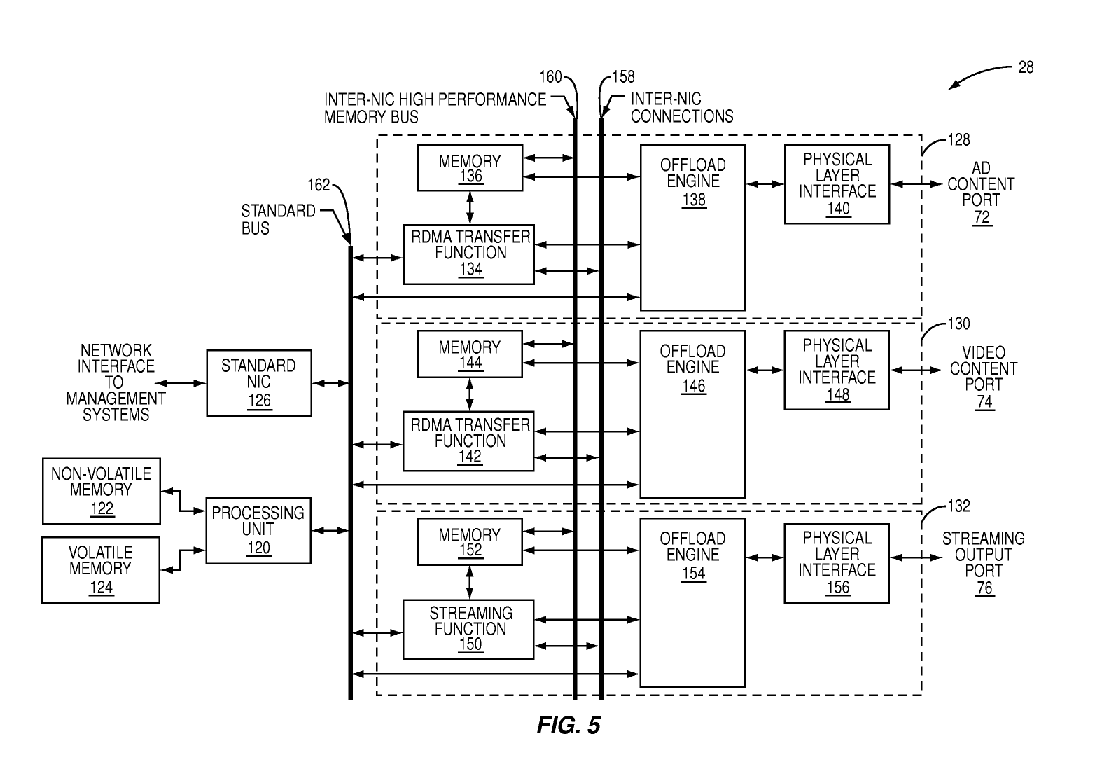

FIG. 5 illustrates one implementation of the RDMA to IPTV streamer 28 according one embodiment of the present invention. Again, this discussion is equally applicable to the other RDMA to IPTV streamers. In general, the RDMA to IPTV streamer 28 includes a control system including a processing unit 120, non-volatile memory 122 such as a hard disk drive, and volatile memory 124 such as RAM. The operating system 108 (FIG. 2) may be implemented as software stored in memory 124 and instruct the processing unit 120 to operate accordingly. The RDMA to IPTV streamer 28 also includes one or more standard Network Interface Cards (NICs) 126 providing the one or more management ports 118 (FIG. 2). The RDMA to IPTV streamer 28 also includes NICs 128-132 forming the ad content port 72, the video content port 74, and the streaming output port 76, respectively. Note that while this embodiment includes three NICs 128-132, the present invention is not limited thereto. For example, all three ports 72-76 may be implemented by a single NIC or two of the ports 72-76 may be collapsed into a single NIC. The NICs 128-132 are preferably implemented in hardware.

The NIC 128 includes an RDMA transfer function 134, memory 136, an offload engine 138, and a physical layer interface 140. The RDMA transfer function 134 is a hardware implementation of the RDMA layer 86 of FIG. 2. The RDMA transfer function 134 may be implemented in an FPGA, ASIC, or the like. The memory 136 may be, for example, RAM or a RAM disk. In one embodiment, the ad buffers 82-1 through 82-N are implemented in the memory 136. The offload engine 138 is a hardware implementation of the protocol stack between the RDMA layer implemented by the RDMA transfer function 134 and the physical layer implemented by the physical layer interface 140. The offload engine 138 may provide a single protocol stack optimized for IB, RoE over a LAN, RoE over a WAN, or iWARP. Alternatively, the offload engine 138 may provide multiple protocol stacks such as an IB optimized protocol stack, a RoE optimized protocol stack, and an iWARP optimized protocol stack. The physical layer interface 140 provides the physical connection to the associated network, which for the RDMA to IPTV streamer 28 of FIG. 1 is the LAN of the central headend 12. In a similar fashion, the NIC 130 includes an RDMA transfer function 142, memory 144, an offload engine 146, and a physical layer interface 148.

The NIC 132 includes a streaming function 150, memory 152, an offload engine 154, and a physical layer interface 156. The streaming function 150 is a hardware implementation of the playback streamers 78-1 through 78-N. The streaming function 150 may be implemented in an FPGA, ASIC, or similar technology. The offload engine 154 implements the protocol stack between the streaming function 150 and the physical layer interface 156. The physical layer interface 156 is the hardware implementation of the physical interface 106 in FIG. 2.

In this example, the RDMA transfer functions 134 and 142 and the streaming function 150 are interconnected by inter-NIC connections 158. Similarly, the memory units 136, 144, and 152 are interconnected by an inter-NIC high performance memory bus 160. The RDMA transfer functions 134 and 142 and the streaming function 150 are interconnected to the processing unit 120 and the standard NIC 126 for the management ports 118 via a standard bus 162. Note that the standard bus 162 may also be used to interconnect the functions 134, 142, and 150 and/or the memory units 136, 144, and 152 in place of or in addition to the inter-NIC connections 158 and the inter-NIC high performance memory bus 160.

In one embodiment, the ad buffers 82-1 through 82-N are implemented in the memory 136 of the NIC 128, and the video buffers 84-1 through 84-N are implemented in the memory 144 of the NIC 130. However, the present invention is not limited thereto. For example, the ad buffers 82-1 through 82-N and the video buffers 84-1 through 84-N may be implemented on the memory units 136, 144, and 152 in any manner needed or desired. The ad buffers 82-1 through 82-N and the video buffers 84-1 through 84-N may then be accessed via the inter-NIC high performance bus 160 as needed or desired.

The present invention provides substantial opportunity for variation. For example, while RDMA is discussed herein, it should be noted that any equivalent technology enabling direct memory to memory transfers over a network connection may be used. As another example, while the discussion above has focused on the RDMA to IPTV streamers 28, 30, 48, 50, 64, and 66 as implemented within the headends 12-16, the present invention is not limited thereto. The RDMA to IPTV streamers may be implemented in any type of system where late-binding of advertisements to video content (or some other form of entertainment content) is needed or desired. For example, the RDMA to IPTV streamers may be used to provide late-binding of advertisements to video content streamed to client devices via the Internet. In addition, while IPTV is the streaming technology discussed above, the present invention is not limited thereto. The streamers 28, 30, 48, 50, 64, and 66 may use other streaming technologies as needed or desired.

Those skilled in the art will recognize improvements and modifications to the preferred embodiments of the present invention. All such improvements and modifications are considered within the scope of the concepts disclosed herein and the claims that follow.

What is claimed is:

1. A method comprising:
at a first network node, receiving a request for select video content;
obtaining a range of addresses in a storage device associated with a video content server allocated for the select video content;
initiating a direct memory-to-memory transfer of at least a portion of the select video content from the range of addresses in the storage device to a video content buffer associated with the first network node via a network connection; and
streaming the select video content from the video content buffer to a client device.

2. The method of claim 1 wherein the direct memory-to-memory transfer is a Remote Direct Memory Access (RDMA) transfer.

3. The method of claim 1 further comprising:
detecting an upcoming advertisement slot in the select video content;
obtaining an advertisement for the advertisement slot from an advertisement content server; and
inserting the advertisement into the advertisement slot as the select video content is streamed to the client device.

4. The method of claim 3 wherein obtaining the advertisement for the advertisement slot comprises initiating a direct memory-to-memory transfer of the advertisement from a storage device associated with the advertisement content server to an advertisement buffer associated with the first network node via a network connection.

5. The method of claim 4 wherein the direct memory-to-memory transfer of the advertisement is an RDMA transfer.

6. The method of claim 3 wherein obtaining the advertisement for the advertisement slot comprises:
selecting one of a plurality of advertisement categories for the advertisement slot;
obtaining information identifying a range of addresses in a storage device associated with the advertisement content server allocated for the one of the plurality of advertisement categories; and
initiating an RDMA transfer of the advertisement for the advertisement slot from the range of addresses in the storage device associated with the advertisement content server to an advertisement buffer associated with the first network node;
wherein inserting the advertisement into the advertisement slot comprises inserting the advertisement from the advertisement buffer into the advertisement slot as the select video content is streamed to the client device.

7. The method of claim 6 wherein selecting the one of the plurality of advertisement categories for the advertisement slot comprises selecting the one of the plurality of advertisement categories based on a comparison of information describing the plurality of advertisement categories and at least one of a group consisting of: information describing the select video content and a viewer profile of a viewer associated with the client device.

8. The method of claim 7 wherein the viewer profile comprises at least one of a group consisting of: demographic information describing the viewer, biographical information describing the viewer, information identifying or describing video content previously viewed by the viewer, information identifying or describing at least one advertisement previously skipped by the viewer, information identifying or describing at least one advertisement previously viewed by the viewer, and information identifying at least one preference of the viewer.

9. The method of claim 1 wherein streaming the select video content from the video content buffer to the client device comprises streaming the select video content to an edge device, wherein the edge device provides the streaming content to the client device via a Switched Digital Video (SDV) channel.

10. The method of claim 1 wherein the select video content is one of a group consisting of: a movie, a television program, and video content from a broadcast television channel.

11. The method of claim 1 further comprising:
receiving, at the first network node, a request to provide second video content to a second client device;
obtaining information identifying a second range of addresses in the storage device associated with the video content server allocated for the second video content;
initiating a direct memory-to-memory transfer of at least a portion of the second video content from the second range of addresses in the storage device to a second video content buffer associated with the first network node; and
streaming the second video content from the second video content buffer to the second client device.

12. The method of claim 1 wherein the first network node is interconnected to the video content server via a Wide Area Network (WAN).

13. The method of claim 1 wherein the first network node is interconnected to the video content server via a Local Area Network (LAN).

14. A system comprising:
a) a video buffer; and
b) a playback streamer associated with the video buffer and adapted to:
i) obtain information identifying a range of addresses in a storage device associated with a video content server allocated for select video content in response to a request to stream the select video content to a client device;
ii) initiate a direct memory-to-memory transfer of at least a portion of the select video content from the range of addresses in the storage device to the video content buffer via a network connection; and
iii) stream the select video content from the video content buffer to the client device.

15. The system of claim 14 wherein the direct memory-to-memory transfer is a Remote Direct Memory Access (RDMA) transfer.

16. The system of claim 14 wherein the playback streamer is further adapted to:
detect an upcoming advertisement slot in the select video content;
obtain an advertisement for the advertisement slot from an advertisement content server; and
insert the advertisement into the advertisement slot as the select video content is streamed to the client device.

17. The system of claim 16 further comprising:
an advertisement buffer associated with the playback streamer; and
a Remote Direct Memory Access (RDMA) enabled interface;
wherein in order to obtain the advertisement, the playback streamer is further adapted to initiate an RDMA transfer of the advertisement from a storage device associated with the advertisement content server to the advertisement buffer via the RDMA enabled interface.

18. The system of claim 16 further comprising:
an advertisement buffer associated with the playback streamer; and
a Remote Direct Memory Access (RDMA) enabled interface;
wherein in order to obtain the advertisement, the playback streamer is further adapted to:
select one of a plurality of advertisement categories for the advertisement slot;
obtain information identifying a range of addresses in a storage device associated with the advertisement content server allocated for the one of the plurality of advertisement categories; and
initiate an RDMA transfer of the advertisement for the advertisement slot from the range of addresses in the storage device associated with the advertisement content server to the advertisement buffer via the RDMA enabled interface.

19. The system of claim 18 wherein the playback streamer is further adapted to insert the advertisement from the advertisement buffer into the advertisement slot as the select video content is streamed to the client device.

20. The system of claim 18 wherein the playback streamer is further adapted to select the one of the plurality of advertisement categories for the advertisement slot based on a comparison of information describing the plurality of advertisement categories and at least one of a group consisting of: information describing the select video content and a viewer profile of a viewer associated with the client device.

21. The system of claim 20 wherein the viewer profile comprises at least one of a group consisting of: demographic information describing the viewer, biographical information describing the viewer, information identifying or describing video content previously viewed by the viewer, information identifying or describing at least one advertisement previously skipped by the viewer, and information identifying or describing at least one advertisement previously viewed by the viewer.

22. The system of claim 14 further comprising an edge device adapted to:
receive the select video content streamed from the playback streamer; and
provide the select video content streamed from the playback streamer to the client device via a Switched Digital Video (SDV) channel.

23. The system of claim 14 wherein the select video content is one of a group consisting of: a movie, a television program, and video content from a broadcast television channel.

24. The system of claim 14 further comprising:
a second video buffer; and
a second playback streamer associated with the second video buffer and adapted to:
obtain information identifying a second range of addresses in the storage device associated with the video content server allocated for second video content in response to a request to stream the second video content to a second client device;
initiate an RDMA transfer of at least a portion of the second video content from the second range of addresses in the storage device to the second video buffer; and
stream the second video content from the second video buffer to the second client device.

25. The system of claim 14 wherein the playback streamer is interconnected to the video content server via a Wide Area Network (WAN).

26. The system of claim 14 wherein the playback streamer is interconnected to the video content server via a Local Area Network (LAN).

27. A system comprising:
a plurality of video buffers; and
a plurality of playback streamers, each of the plurality of playback streamers associated with one of the plurality of video buffers and adapted to:
obtain information identifying a range of addresses in a storage device associated with a video content server allocated for select video content in response to a request to stream the select video content to an associated client device;
initiate a direct memory-to-memory transfer of at least a portion of the select video content from the range of addresses in the storage device to a corresponding one of the plurality of video buffers via a network; and
stream the select video content from the corresponding one of the plurality of video buffers to the associated client device.
